(19) United States
(12) Patent Application Publication
(10) Pub. No.: US 2008/0153357 A1
(43) Pub. Date: Jun. 26, 2008

(54) Telecommunications Module, Assemblies Thereof and Methods of Making and Using Same

(76) Inventors: Johann Hajok, Bochum (DE); Wolfgang Edelmann, Wuppertal (DE)

Correspondence Address: 3M INNOVATIVE PROPERTIES COMPANY, PO BOX 33427, ST. PAUL, MN, 55133-3427, US

(21) Appl. No.: 11/815,915

(22) PCT Filed: Mar. 2, 2006
(86) PCT No.: PCT/US2006/007684

§ 371 Date: Aug. 9, 2007

(30) Foreign Application Priority Data
Mar. 4, 2005 (EP) 05004812.3

(51) Int. Cl. H01R 31/00

(52) U.S. Cl. 439/626

(57) ABSTRACT

A telecommunications module (1) having a housing (2) with a first side (2a), a second side (2b) and an outer surface (2c), and at least one contact (3) comprising a first contact portion (3a) provided at the first side (2a) of the housing (2) and a second contact portion (3b) provided at the second side (2b) of the housing (2), wherein said at least one contact (3) further comprises a third contact portion (3c) provided at the first (2a) or second side (2b) on the outer surface (2c) of the housing (2) for providing an outside connection point to the contact (3). Assemblies of a telecommunications module and at least one outside module and methods of using such assemblies are also disclosed.

### TECHNICAL FIELD

The invention relates to a telecommunications module, an assembly of a telecommunications module and at least one outside module, a method for manufacturing a telecommunications module, and a use of a telecommunications module.

### RELATED ART

In the field of telecommunications, numerous customers are connected with the switch of a telecommunications company via telecommunications lines. The customers can also be called subscribers. The switch is also called an exchange or PBX (central office exchange operated by the telecommunications company). Between the subscriber and the switch, sections of the telecommunications lines are connected with telecommunications modules. The telecommunications modules, such as the disconnection strips ID3000 made by Quante AG, 3M Telecommunications of Neuss, Germany, establish an electrical connection between a wire, which is attached to the telecommunications module at a first side, and another wire, which is attached to the telecommunications module at a second side. The wires of one side can also be called incoming wires and the wires of the other side can be called outgoing wires. Plural telecommunications modules can be put together at a distribution point, such as a main distribution frame, an intermediate distribution frame, an outside cabinet or a distribution point located, for example, in an office building or on a particular floor of an office building. To allow flexible wiring, some telecommunications lines are connected with first telecommunications modules in a manner to constitute a permanent connection. Flexibility is realized by so-called jumpers or cross connects, which flexibly connect contacts of the first telecommunications module with contacts of a second telecommunications module. These jumpers can be changed when a person moves within an office building to provide a different telephone (i.e. a different telephone line) with a certain telephone number, which the relocated person intends to keep. In the telecommunications module, disconnection points can be located in the electrical connection between the two sides. At such disconnection points, disconnection plugs can be inserted, in order to disconnect the line. Furthermore, protection plugs and magazines are known. These are connected to the module and protect any equipment connected to the wires from overcurrent and overvoltage. Finally, test plugs can be inserted at a disconnection point in order to test or monitor a line.

Recently, ADSL-technology has spread widely in the field of telecommunications. This technology allows at least two different signals to be transmitted on a single line. This is achieved by transmitting the different signals at different frequencies along the same line. The signals are combined at a particular point in the telecommunications line and split at another point. In particular, at the subscriber side, voice and data signals, which are separate, are combined and sent to the central office via the same line. In the central office the combined signal is split. For the transmission of voice and data signals to the subscriber, separate voice and data signals are combined at the central office, sent to the subscriber and split at the subscriber side. After splitting the signal, the so-called POTS-signal (plain old telephone service) can be used to transmit voice signals. The remaining part of the split signal can be used to transmit data, for example. So-called splitters, which are used to split or combine the signal, can generally be arranged at any distribution point.

Any electronic components, which are necessary to perform the above functions, can be contained, possibly together with a printed circuit board as a base, in a functional module, which can be called a splitter module. Similar functional modules are protection modules, which contain any components which provide protection against overvoltage and/or overcurrent, as well as testing and monitoring modules, which contain suitable electronic components and circuits in order to test and/or monitor a telecommunications line. Furthermore, other functional modules in the above sense are known to those skilled in the art.

An over-voltage protection cartridge is commercially available from Quante, 3M Telecommunications of Neuss, Germany under the designation OVP-magazine. This cartridge has a plurality of pairs of contacts, which are insertable into a receiving space of a telecommunications module. When the cartridge is fully inserted, a lever of the cartridge is turned so as to spread the contacts of the cartridge apart. This applies a biasing force to the contacts of the telecommunications module so as to establish a reliable electrical connection.

EP 04 006 530.2 of the Applicant describes an assembly of three telecommunications modules, to which a splitter module can be fitted from a rear side of the telecommunications module. An electrical connection between the contacts of the telecommunications modules and the outside contacts of the splitter module is established. Similar assemblies are known from the Applicant's EP 04 006 529.4 and EP 04 027 881.4.

As mentioned above, the functional modules (referred to also as outside modules in the following) are inserted into a receiving space of a telecommunications module which forms the connection to the other side of the telecommunications module where connections to jumpers and the like are provided. Therefore, if both contact portions, incoming and outgoing, of the telecommunications module are occupied by functional modules, jumpers, or wires, no additional contact portions are available for the provision of additional functional modules, such as OVPs or test equipment. It is then, in general, necessary to temporarily disconnect a contact portion on one side to connect functional modules for test purposes and to temporarily reroute the line, or, if a permanent provision of an additional functional module is needed, to daisy chain functional modules across plural connections in the telecommunications module. Both solutions are disadvantageous as they require additional work, decrease the connection density achievable in the telecommunications module, and as a result increase costs for the equipment operator.

### SUMMARY OF THE INVENTION

The invention provides a telecommunications module, which is improved with regard to connectability with plural and different types of outside modules. This is achieved by providing an additional connection point on the outer surface of the telecommunications module, which can serve as a reliable and permanent contact portion for the connection of outside modules. This achieves greater flexibility, ease-of-use and economy of time associated with the installation, handling and maintenance of connections provided by the telecommunications modules. Furthermore, an assembly of a telecommunications module and at least one outside module, a method of manufacturing a telecommunications module as well as a use of a telecommunications module of the present invention are provided.

The telecommunications module according to the present invention comprises a housing, which can be made of plastic or any other suitable material and can be constituted by one or more components. The housing is formed so as to have at least a first side and a second side as well as an outer surface. The housing serves to accommodate the contacts of the telecommunications module, as will be described in detail below. The housing can also have specific structures for positioning the contacts therein or thereon. Moreover, the housing can comprise one or more cavities or receiving spaces, which are adapted to accommodate objects such as the functional modules described above or any other types of outside modules or parts, such as contacts, thereof. The receiving space can at least partially be located outside the housing of the telecommunications module and essentially means any space, which allows the outside contact of an outside module to be at least partially accommodated therein. Generally, the receiving space can be at any suitable side of the telecommunications module. However, it is considered advantageous to provide access to the receiving space at a second (rear) side of the telecommunications module, when wires are connected to the contacts of the telecommunications module at a first (front) side thereof. Thus, any outside modules, which are at least partially inserted into the receiving space, do not interfere with wires connected to the telecommunications module. Thus, the handling properties of the novel telecommunications module are improved. Finally, the housing can comprise suitable structures, typically at the outside thereof, to enable the telecommunications module to be mounted to a rack or any other suitable carrier in the field of telecommunications.

The telecommunications module further comprises at least one contact comprising a first contact portion provided on the first side of the housing and a second contact portion provided on the second side of the housing. Here, a contact generally means any component, which is adapted to establish an electrical connection with at least one outside wire and/or outside contact. A contact portion is any area or part of the contact, where this connection is made. For this purpose, the contact can, for example, at a first contact portion thereof, be formed as an IDC (Insulation Displacement Contact), a wire wrap contact or in any other suitable manner. On the first contact portion thereof a wire can be connected, and on a second contact portion thereof an electrical connection with a further component can be established. This can, for example, be the outside contact of an outside module, such as splitter module. In this case, the signal, which is transmitted from the wire to the contact, is further transmitted to the electronic components of the splitter modules and is processed by these. It is further conceivable that the contact comprises separate contact elements, such as a first and second contact element. On the first contact portion of the first contact element a wire can be connected. The second contact portion of the second contact element can, for example, be connected with a splitter module. The connection between the first and second contact element is established at a disconnection point between the second portion of the first contact element and the first portion of the second contact element, where it can be disconnected by means of a disconnection plug, for example. In a connected state the signal, which is processed, split or combined by the splitter module is, via the second contact element, the disconnection point and the first contact element, transmitted to the wire connected with the first contact portion of the first contact element. It is, however, to be emphasized that a particular contact of the telecommunications module described herein does not necessarily comprise two contact elements, but one contact element, called simply the contact, can be sufficient. Moreover, a contact portion as defined here can be an end, a protrusion, branch or the like of the contact, but may also be understood as merely meaning a surface or a particular side of the contact.

The at least one contact comprises further a third contact portion provided at the first or second side on the outer surface of the housing for providing an outside connection point to the contact. This provides the possibility to conveniently connect, either permanently or temporarily, contacts of additional outside modules, such as the functional modules described above, to the telecommunications module without disturbing any connections established at the first and/or second contact portions of the contact. Further, the provision of the third contact portion on the outer surface of the housing allows connections to be established thereto without disturbing any connections present at contact portions inside the housing. As the third contact portion is provided on the same side of the housing as one of the first or second contact portions, the two contact portions may also be contacted by a single outside module.

The contact portions mentioned herein may be formed in any suitable way that permits them to be contacted by contacts of outside modules, wires and the like. For instance, the second contact portion may comprise a bulge or bead-like protrusion, and be flexible so as to contact essentially rigid contacts such as those of a PCB. The second contact portion may also be essentially straight and be supported by the housing so as to contact essentially flexible outside contacts such as those of an overvoltage protection module (OVP-M). Alternatively, a combination of these features is conceivable. Additionally, all features of the telecommunications module, in particular the contacts thereof, described in the patent application “A Telecommunications Module, an Assembly of a Telecommunications Module and at least one Outside Module and a Method of using a Telecommunications Module” filed on Mar. 4, 2005 by the present applicant are incorporated herein by reference and can be combined with any features herein.

In a preferred embodiment, the first side and the second side of the housing, as defined here, are opposite each other. This is the common configuration of disconnection strip housings, such as the ID3000 of Quante AG. In general, these sides may also be located adjacent to each other, such as at 90° to each other, if special applications should require so. Also, it is preferred that the first and/or second contact portion can at least be partially located inside the housing. This means that the contact is established within a receiving space rather than on the surface of the housing.

Preferably, the first and/or second contact portion is displaced from the contact. This means that the first and/or second contact portion is oriented away from a main direction of orientation of the contact, i.e. the first and/or second contact portion is, for example, bent away from a remaining portion of the contact. More preferably, the first and/or second contact portion is punched from the contact and bent therefrom, while remaining integrally linked thereto. Still more preferably, the first and/or second contact portion is punched from the contact such that the third contact portion has a frame-like shape. This means that, for example, the first and/or second contact portion has three of four sides cut from the contact and remains integrally linked to the contact through the fourth uncut side, thereby resulting in a frame-shaped third contact portion. This configuration of the contact portions brings the advantage that it is easily manufactured from, for instance, a strip of conductive material, such as copper or aluminium.

On the other hand, according to another embodiment of the present invention, the first and/or second contact portion are soldered or welded to the contact and thus integrally linked to it, and to the remaining portions of the contact.

This alternative embodiment is suitable for situations in which a contact with the three mentioned contact zones formed as described above is not easily incorporated into a housing, and where the contact portions may only be incorporated separately. In this case, the electrical connection can be established by providing a soldered or welded joint between the first and/or second contact portion and the remaining portions of the contact.

As indicated above, the invention also provides an assembly of a telecommunications module according to one of the above-described embodiments of the present invention and at least one outside module. These outside modules will have at least one outside contact connectable to one of the contact portions of the present invention, preferably the contact portions situated on the same side of the housing. In such a combination with at least one outside module, the advantages of the novel telecommunications module brought about by the additional outside connection point can be used for the connection with at least one outside module. Thus, additional functions, such as overvoltage or overcurrent protection, grounding, splitting or combining of a signal and/or testing functions can be provided without disturbing the other connections present at the other two (occupied) contact portions. Moreover, according to the particular configuration of the contact portions, different types of outside modules can be combined with one and the same telecommunications module at a certain point in time in order to provide different services and/or protection to different telecommunications lines.

Preferably, the at least one outside module of above-mentioned assembly comprises a grounding contact. This permits, for instance, the connection of shielding or grounding plates to the contact of the telecommunications module.

It is also preferred, that the at least one outside contact of the above-mentioned assembly comprises a PCB. In this way, signals from the contact of the telecommunications module can be separately processed, according to the specific task, by the electronic circuits of the PCB.

As examples for outside modules, with which the telecommunications module described herein can be advantageously combined, an overvoltage protection, a test module and/or a splitter module can be mentioned.

The invention also provides a method of manufacture of the telecommunications module in one of the above-described embodiments, which comprises the steps of providing a housing having a first and a second side and an outer surface, forming at least one contact having at least three contact portions, combining the at least one contact with the housing such that the first contact portion is provided at the first side, the second contact portion is provided at the second side, and the third contact portion (3c) is provided at the first or second side on the outer surface of the housing for providing an outside connection point to the contact.

Preferably, in the method for manufacturing a telecommunications module, the step of forming at least one contact having at least three contact portions comprises a step of bending the first and/or second contact portion. The step of bending can also be substituted with any other step which suitably modifies the form of the contact so as to displace the first and/or second contact portion from the main orientation of the contact, as mentioned above.

More preferably, in the method for manufacturing a telecommunications module, the step of forming at least one contact having at least three contact portions comprises a step of punching the first and/or second contact portion from the contact and bending it therefrom, while the first and/or second contact portion remains integrally linked to the contact. Still more preferably, in the method for manufacturing a telecommunications module, the step of forming at least one contact having at least three contact portions comprises a step of punching the first and/or second contact portion from the contact so that a remaining portion of the contact, where the first and/or second contact portion was punched, forms the third contact portion, the third contact portion having a frame-like shape.

According to another embodiment of the present invention, a method for manufacturing a telecommunications module, wherein initially the contact portions of the contact are not all integrally linked, comprises the steps of providing a housing having a first and a second side and an outer surface, forming at least one contact having at least three contact portions, combining the at least one contact with the housing such that the first contact portion is provided at the first side, the second contact portion is provided at the second side, and the third contact portion is provided at the first or second side on the outer surface of the housing for providing an outside connection point to the contact. Preferably, in the method for manufacturing a telecommunications module, the step of forming at least one contact comprises a step of welding or soldering the first and/or second portion to the contact.

Finally, the invention also provides a use of a third contact portion of a contact which is accommodated in a telecommunications module having a housing with a first side and a second side and comprises a first contact portion provided at the first side of the housing and a second contact portion provided at the second side of the housing, and the third contact portion provided at the first or second side of the housing as an outside connection point to the contact.

As examples of such use one can mention the outside connection of an OVP module, of a splitter module, or of test modules to the third contact portion. Alternatively, a grounding contact may be connected to the third contact portion.

### BRIEF DESCRIPTION OF THE DRAWINGS

In the following, the invention will be described by non-limiting examples thereof with reference to the following drawings, in which:

FIG. 1 shows a schematic sectional side view of an embodiment of the telecommunications module, in combination with an outside module, which in 1a) is an OVP module, and in 1b) is a PCB.

FIG. 2 shows a top view of the second side (rear) of the telecommunications module according to an embodiment of the present invention.

FIG. 3 shows a sectional side view of the second side (rear) of the telecommunications module according to an embodiment of the present invention.

FIG. 4 shows a sectional side view of an assembly of the telecommunications module of FIG. 1 and two outside modules according to an embodiment of the present invention.

### DESCRIPTION OF PREFERRED EMBODIMENTS OF THE INVENTION

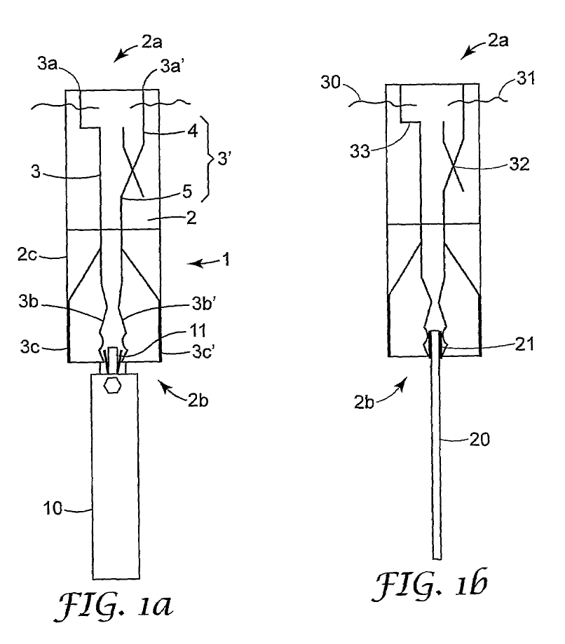

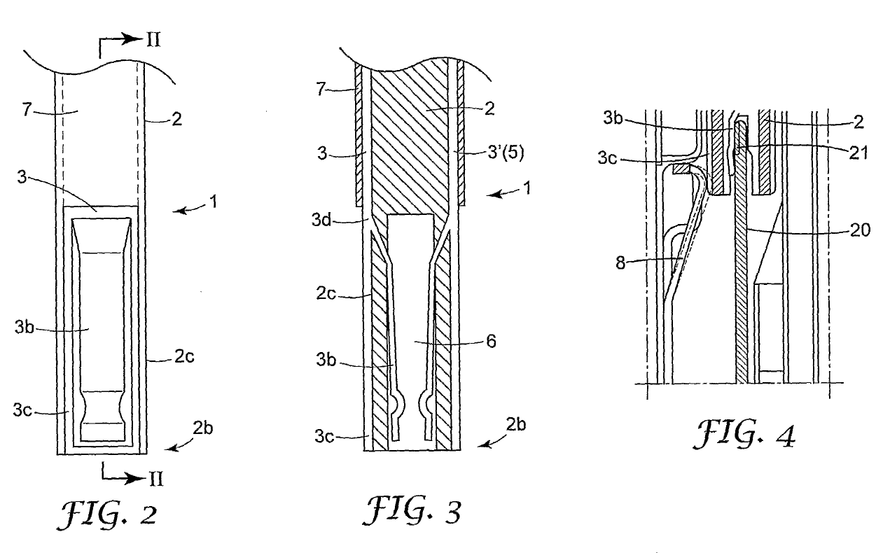

With reference to FIG. 1, the general construction of the telecommunications module 1 will be described. The telecommunications module 1 comprises a housing 2 having a first side 2a, a second side 2b as well as a surface 2c. Within the housing 2, a first contact 3 and a second contact 3′, the latter consisting of contact elements 4 and 5, are accommodated. Note that the contacts are essentially shown as relatively thick lines. However, as can be seen from FIG. 2, the contacts will usually be formed as strip-like elements with a width extending perpendicular to the plane of the drawing of FIG. 1. Moreover, further contacts 3 and 3′ can be present “in front of” and “behind” the plane of the drawing of FIG. 1. Thus, as will be apparent to those skilled in the art, the housing will have a certain extension in a direction perpendicular to the plane of the drawing. The width of the contacts can be a few millimeters, for example, in one exemplary embodiment, so as to allow an IDC to be formed on the contacts, so that wires 30, 31 can be connected therewith.

The contacts 3 and 3′ each comprise three contact portions, a first contact portion 3a, 3a′ on a first (front) side 2a of the housing, and a second contact portion 3b, 3b′ provided on the second (rear) side 2b of the housing 2. A third contact portion 3c, 3c′ is provided on the second (rear) side on the outer surface 2c of the housing 2.

In the embodiment shown, the first contact portions 3a, 3a′ comprise a contact slit (not visible in FIG. 1) or insulation displacement connector or contact (IDC) slit into which the wires 30, 31 are inserted from the first (front) side 2a of the telecommunications module 1. Also, the first contact portion 3a of contact 3 comprises an optional step 33, which can, for example, be provided in order to reliably position the first contact 3 within the housing 2. In a part extending towards the second (rear) side 2b of the housing 2, the contact element 5 is formed in a relatively flat V-type projection, which cooperates with a similar projection formed on the contact element 4 in a part extending toward the first (front) side 2a. The projections are directed to each other, so that a disconnection point 32 is formed. The V-shaped is an exemplary embodiment. It is understood that the exact configuration of the contact element at disconnection point 32 may be selected as desired. In the situation, which is shown in FIG. 1, an electrical connection between the contact elements 4 and 5 is established at disconnection point 32. However, an outside module or plug (not shown), such as a test plug, can be inserted from the front 2a of a telecommunications module 1 so as to disconnect contact elements 4, 5 at the disconnection point 32. The described projections will then be in contact with the outside module or plug in order to allow the desired function to be performed by the module or plug.

A similar disconnection point is provided at the second (rear) side of the telecommunications module 1 between contact 3 and contact 3′. Flat V-type projections, for example, of the second contact portion 3b and 3b′, as described above with regard to disconnection point 32, can be taken from the drawing. It is to be noted that FIG. 1 shows situations in which an outside module, such as an overvoltage protection module 10 or a PCB 20 is inserted into the telecommunications module 1 from the second side (rear) 2b thereof. However, when such a module 10, 20 is not inserted, the second contact portions 3b and 3b′ can be in contact with each other at the disconnection point, which is formed by the V-shaped protrusions. Thus, direct electrical connection can be established between wires 30 and 31 via contacts 3 and 3′.

As can be seen from FIGS. 2 and 3, the contact 3 (and analogously for 3′) runs along the housing 2 from the first (front) side 2a towards the second (rear) side being covered by an outer housing 7. The outer housing 7 ends in correspondence to the location 3d, (as seen in FIG. 3) at which the second contact portion 3b branches off the contact 3. There, in proximity to the second (rear) side of the housing 2, the second contact portion 3b is partially punched out from the contact 3 leaving a frame-like third contact portion 3c on the outer, exposed surface 2c of the housing 2. At the location 3d, the second contact portion 3b remains electrically and mechanically linked to the contact 3 and is bent from this location 3d inwards into a receiving space 6 of the housing 2. In the situation shown in FIG. 3, the contact portions 3b are not in contact with each other, although the outside module 10, 20 (see FIGS. 1a and 1b) is removed. However, the contact portions 3b can also be formed and provided in a manner, so that they are in contact with each other, when the outside module 10, 20 is removed. In the situation shown in FIG. 1a) and 1b), both the contact portions 3b and 3b′ are connected with outside contacts 11 and 21 of the outside module 10 and 20, respectively. For this purpose, the outside module 10 or 20 is partially inserted into the receiving space 6, which is defined between the contact portions 3b and 3b′. With wires attached to the contact portions 3a, 3a′ and outside modules occupying the contact portions 3b, 3b′, it is still possible to connect additional equipment to the contacts 3, 3′ by using the third contact portions 3c, 3c′ on the outer surface 2c on the second (rear) side 2b of the housing 2.

In FIG. 4 an assembly of the telecommunications module of FIGS. 1 is shown with a first outside module, here a PCB 20, contacting the (inner) second contact portion 3b as described above and shown in FIG. 1a) or 1b) and a second outside module, of which a grounding contact 8, contacting the (outer) third contact portion 3c is shown. The analogous connections for contact 3′ are omitted from the figure for clarity. The PCB comprises a contact portion 21, which upon insertion is contacted by the elastic second contact portion 3b of the telecommunications module. The grounding contact 8 is formed as a resilient metal strip which is held in contact with the third contact zone by virtue of its elasticity. In this way, a shielding connection is provided to the contact 3 by the grounding contact 8 (of the second outside module), without the necessity to disconnect the PCB 20 (first outside module) from the second (inner) contact portion 2b. Therefore, even when the telecommunications module comprises a plurality of adjacent closely spaced contacts 3, 3′ and its front 3a, 3a′ and rear contact portions 3b, 3b′ are occupied, no disconnection or rerouting of lines is needed in order to perform maintenance or upgrading work, such as connecting shielding, safety or test equipment. In the assembly described with reference to FIG. 4, two outside modules are partially inserted and/or fitted to the telecommunications module. In particular, the contact portions of 3b and 3c are used by contacts 21, 8 of different outside modules.

For example, the contact 8 can be provided on a housing part, such as a wire guide plate, which can be considered an outside module. The wire guide plate can have suitable grounding contacts to connect the contact 3 with ground.

It is, however, to be understood that these contacts can also be formed differently and, particularly, be provided on one and the same outside module. In this case, the outside module can be contacted with those contact portions 3b, 3c at the same time. For example, a splitter module can have splitter circuits and a grounding contact, so that both contacts 21, 8 can be connected with contact portions 3b, 3c for the specific purpose.

The present invention has now been described with reference to an embodiment thereof. The foregoing detailed description and embodiment have been given for clarity of understanding only. No unnecessary limitations are to be understood therefrom. For example, all references to right, left, front and rear are exemplary only and do not limit the claimed invention. It will be apparent to those skilled in the art that many changes can be made to the embodiment described without departing from the scope of the invention. Thus, the scope of the present invention should not be limited to the exact details and structures described herein, but rather by the structures described by the language of the claims, and the equivalents of those structures.

1. A telecommunications module with contacts for connecting wires therewith having a housing with a first side, a second side and an outer surface, and at least one contact comprising a first contact portion provided at the first side of the housing and a second contact portion provided at the second side of the housing, wherein the at least one contact further comprises a third contact portion provided at the first or second side on the outer surface of the housing for providing an outside connection point to the contact.

2. The telecommunications module according to claim 1 wherein the first side and the second side of the housing are opposite each other.

3. The telecommunications module according to claim 1 wherein the first and/or the second contact portion are inside the housing.

4. The telecommunications module according to claim 1 wherein the first and/or the second contact portion is displaced from the contact.

5. The assembly of a telecommunications module according to claim 1 and at least one outside module.

6. The assembly according to claim 5 wherein the outside module comprises a grounding contact.

7. The assembly according to claim 5 wherein the outside module comprises a printed circuit board.

8. A method for manufacturing a telecommunications module comprising:
providing a housing having a first and a second side and an outer surface;
forming at least one contact having three contact portions;
combining the at least one contact with the housing such that the first contact portion is provided at the first side, the second contact portion is provided at the second side, and the third contact portion is provided at the first or second side on the outer surface of the housing for providing an outside connection point to the contact.

9. The method for manufacturing a telecommunications module according to claim 8 wherein the step of forming at least one contact having three contact portions comprises a step of bending the first and/or second contact portion.

10. The method for manufacturing a telecommunications module according to claim 8 wherein the step of forming at least one contact having three contact portions comprises a step of punching the first and/or second contact portion from the contact so that a remaining portion of the contact, where the first and/or second contact portion was punched, forms the third contact portion, the third contact portion having a frame-like shape.

11. A use of a third contact portion of a contact which is accommodated in a telecommunications module having a housing with a first side and a second side and comprises a first contact portion provided at the first side of the housing and a second contact portion provided at the second side of the housing, and the third contact portion provided at the first or second side of the housing as an outside connection point to the contact.
